(19) United States
(12) Patent Application Publication
(10) Pub. No.: US 2007/0276812 A1
(43) Pub. Date: Nov. 29, 2007

(54) Search Result Ranking Based on Usage of Search Listing Collections

(76) Inventor: Joshua Rosen, Bolinas, CA (US)

Correspondence Address: PATTERSON & SHERIDAN, L.L.P., 3040 POST OAK BOULEVARD, SUITE 1500, HOUSTON, TX, 77056, US

(21) Appl. No.: 11/752,284

(22) Filed: May 22, 2007

Related U.S. Application Data
(60) Provisional application No. 60/803,019, filed on May 23, 2006.

(51) Int. Cl. G06F 17/30

(52) U.S. Cl. 707/3

(57) ABSTRACT

Search results generated in response to a search query includes one or more search listing collections and are ranked based on usage of search listing collections. In the case where search results including individual search listings are ranked, the usage metrics include: the number of times a search result has been added to a search listing collection, the number of times a search result has been viewed within a search listing collection, and the number of click-throughs or the click-through rate of a search result within a search listing collection. In the case where search results including search listing collections are ranked, the usage metrics include: the number of times the search listing collection has been e-mailed to another user or imported by another user, the number of pages that have been added to a search listing collection that are relevant to the search query, the number of times relevant pages within a search listing collection have been viewed, and the number of click-throughs or the click-through rate of the relevant pages within a search listing collection.

### CROSS-REFERENCE TO RELATED APPLICATIONS

This application claims the benefit of U.S. Provisional Patent Application Ser. No. 60/803,019, filed May 23, 2006, the entire contents of which are incorporated by reference herein.

### BACKGROUND OF THE INVENTION

1. Field of the Invention

The present invention relates generally to search engines and, more particularly, to search engines that generate one or more search listing collections as search results and rank the search listing collections based on their content and usage.

2. Description of the Related Art

Search engines have become popular tools to identify and locate specific information on the Internet. A search engine is a computer program that, when queried for information, retrieves either related information or pointers to the location of related information, or both, by evaluating content stored in its search database.

The search engines provided by Internet search services, such as Yahoo!, Google and MSN, accept a search query and returns search results ranked in accordance with their respective relevance algorithm. These search results are displayed through a graphical user interface (GUI) that includes an editable text field that displays the search query, a listing of search results, and a listing of text advertisements known in the art as sponsored links. A click on any of the search results hyperlinks the user to the web site associated with that search result and a click on any of the sponsored links hyperlinks the user to the web site of the sponsor.

One of the more popular ways to rank search results involves analyzing the location and frequency of keywords on a web page. Another frequently used technique is analyzing how web pages are hyperlinked to each other. A web page gets a ranking boost based on the number of other web pages that are hyperlinked to it. This technique is described in U.S. Pat. No. 6,285,999, the entire contents of which are incorporated by reference herein. Click-through rates of search results are analyzed in some search engines. The general rule is: the higher the click-through rate, the higher the ranking. A search engine known as Alexa tracks a user's actions while browsing and derives the relevance of search results based on the browsing histories of its users.

### SUMMARY OF THE INVENTION

The present invention provides another method for ranking search results. In this method, search results are ranked based in part on usage of search listing collections.

In one embodiment where search results including individual search listings are ranked, the usage metrics that may be used include: the number of times a search result has been added to a search listing collection, the number of times a search result has been viewed within a search listing collection, and the number of click-throughs or the click-through rate of a search result within a search listing collection.

In another embodiment where search results including search listing collections are ranked, the usage metrics that may be used include: the number of times the search listing collection has been e-mailed to another user or imported by another user, the number of pages that have been added to a search listing collection that are relevant to the search query, the number of times relevant pages within a search listing collection have been viewed, and the number of click-throughs or the click-through rate of the relevant pages within a search listing collection.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates a networked computer environment in which the present invention may be practiced.

FIG. 1B is a block diagram of an exemplary client computer that is part of the networked computer environment shown in FIG. 1A.

FIG. 2 is a schematic representation of a GUI according to an embodiment of the present invention that displays search listing collections as part of search results.

FIG. 3 illustrates one process for generating the GUI shown schematically in FIG. 2.

FIG. 4A is a flow diagram that illustrates the steps carried out by a server computer to generate search results according to an embodiment of the present invention.

FIG. 4B is a flow diagram that illustrates the steps carried out by a server computer to rank search results according to an embodiment of the present invention.

FIG. 5 is a schematic representation of a GUI according to another embodiment of the present invention that displays search listing collections as part of search results.

FIG. 6 is a flow diagram that illustrates the steps carried out by a server computer to generate search results according to another embodiment of the present invention.

FIG. 7 is a flow diagram that illustrates the steps carried out by a server computer to generate search results according to another embodiment of the present invention.

### DETAILED DESCRIPTION

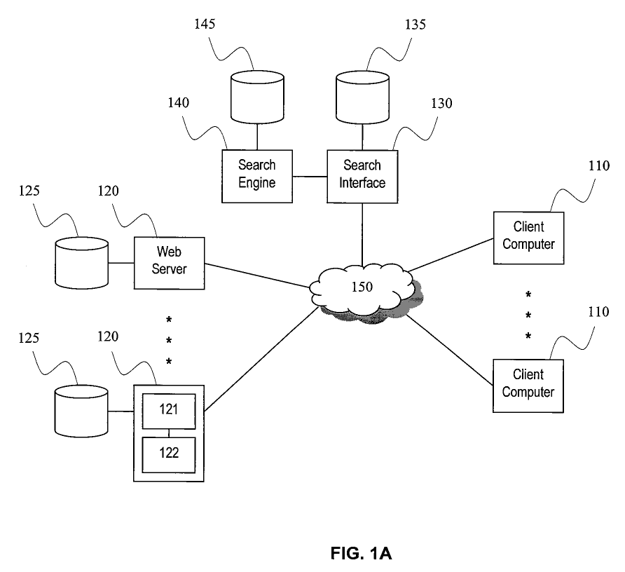

FIG. 1A illustrates a networked computer environment in which the present invention may be practiced. As shown, the networked computer environment includes a plurality of client computers 110 (only two of which are shown), a plurality of web servers 120 with associated content storage units 125 (only two of which are shown), a search interface web server 130 with an associated content storage unit 135, and a search engine web server 140 with an associated content storage unit 145. The client computers 110, the web server computers 120, the search interface web server 130, and the search engine web server 140 are connected over a computer network 150, e.g., the Internet.

The search engine web server 140 may be operated by the same party that is operating the search interface web server 130. In some implementations, the functions of the search interface web server 130 and the search engine web server 140 can be carried out by a single web server. The search engine web server 140 may also be operated by a different party, e.g., an Internet search services provider. As another alternative, the search engine functions may be provided by both the party that is operating the search interface web server 130 and an Internet search services provider.

As illustrated in FIG. 1B, each client computer 110 includes conventional components of a computing device. They include a processor 111, system memory 112 and a hard disk drive 113, that communicate over a bus 114 and are contained within a housing 115, and external devices such as input devices 116, e.g., a mouse and a keyboard, and output devices 117, e.g., a monitor and a printer. Each web server (which may be any of the web servers 120, the search interface web server 130, and the search engine web server 140) includes a processor 121 and a system memory 122, and manages the contents stored in its respective content storage unit using software, e.g., a relational database software. The web server is programmed to communicate with the client computers 110 and other web servers using the TCP/IP protocol. The client computers 110 are programmed to execute web browser programs and access the web pages managed by the web servers by specifying a uniform resource locator (URL) for the web server into the browser.

In the embodiments of the present invention described below, users are respectively operating the client computers 110 that are connected to the search interface web server 130 over the Internet. The web pages that are displayed to a user are transmitted from the search interface web server 130 to that user's client computer 110 and processed by the web browser program stored in that user's client computer 110 for display through the monitor of that user's client computer 110.

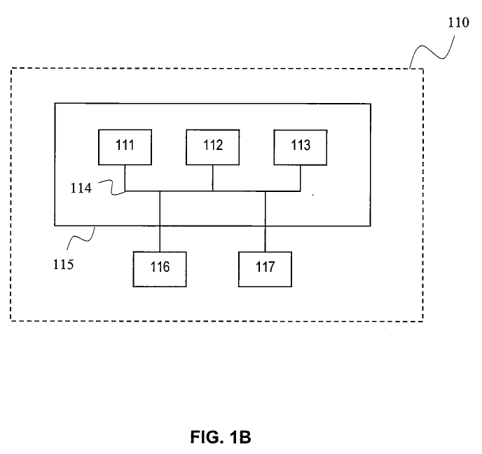

FIG. 2 is a schematic representation of a GUI according to an embodiment of the present invention that displays search listing collections as part of search results. This GUI is generated by the client computer 110 based on content transmitted by the search interface web server 130. The GUI schematically represented in FIG. 2 has four different sections. The first section 210 is a section for collecting search results into user-defined groups, referred to herein as “search listing collections” or “notebooks” and managing the notebooks. A list 201 of three such notebooks is shown in FIG. 2 inside the first section 210. A notebook may be shared with another user using the E-mail hyperlink or by specifying viewing and editing privileges for the other users using the Share hyperlink. A user who has viewing privileges to a notebook may import the notebook into his or her personal collection of notebooks. The second section 220 is a section for inputting a search query. The third section 230 is a section for displaying search results that are responsive to the search query. The fourth section 240 is a section for displaying text advertisements that are responsive to the search query.

Each of the four sections comprises at least one inline frame (also known as iframe). The first section 210 comprises one inline frame. The second section 220 comprises one inline frame. The third section 230 comprises multiple inline frames. Each search result (231a, 231b, 231c, 231d) in the third section 230 is displayed in a separate inline frame. Some search results like the search result 231b and the search result 231c are notebooks that contain multiple pages. Notebooks are distinguished in the GUI from search results containing just an individual search listing using graphics that depict a stack of pages. Also, the displays for notebooks have navigation arrows 232, 233. The search listings from any one notebook are displayed one at a time. Other search listings within the same notebook can be accessed and displayed by clicking on the left arrow 232 to navigate backward through the notebook and on the right arrow 233 to navigate forward through the notebook. The fourth section 240 comprises one inline frame.

A GUI having inline frames permits any one of the inline frame to be updated with new content without disrupting the rest of the GUI. For example, a click on any of the following hyperlinks: Images, News, Blogs, and Y. Pages, within an inline frame of one of the search results 231, which is interpreted as a request to search the Internet for images, news, blogs, or yellow pages, respectively, based on search query and the content of the search result currently displayed in the inline frame, causes only the inline frame to update without disrupting the rest of the GUI. Also, when the user clicks on the GUI controls 232, 233 appearing in the inline frame corresponding to search result 231b (or 231c), the display contents of this inline frame are updated without disrupting the rest of the GUI.

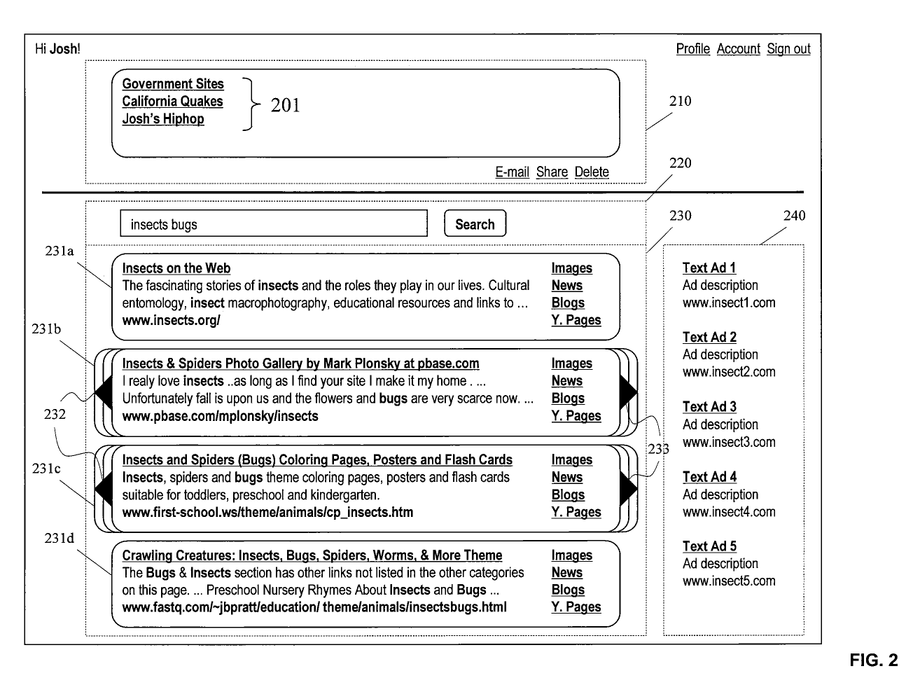

In the process illustrated in FIG. 3, the display contents for GUI 310, exclusive of the search results, are represented as HTML_bg, and the display contents of each of the search results provided in an inline frame are represented as HTMLn. The user input is represented as user_input.

The components of the client computer 110 shown in FIG. 3 include a processor 111 and a memory unit 112. A web browser program is stored in the memory unit 112 and executed by the processor 111 to manage the interactions between it and the search interface web server 130 over the Internet 150. The components of the search interface web server 130 shown in FIG. 3 include a processor 131 and a memory unit 132. A web server program is stored in the memory unit 132 and executed by the processor 131 to manage the interactions between it and the client computer 110 over the Internet 150. The memory unit 132 also stores a program executable by the processor 131 for interacting with the search engine web server 140, e.g., transmitting a search request and receiving search results in response thereto. The components of the search engine web server 140 shown in FIG. 3 include a processor 141 and a memory unit 142. A search engine program is stored in the memory unit 142 and executed by the processor 141 to carry out searches requested by the search interface web server 130.

FIG. 3 illustrates a GUI 310 at two different points in time. Initially, the GUI 310 has no search results displayed. Then, the user submits a search request, represented as user_input, through the GUI 310. The client computer 110 passes on this search request to the search interface web server 130 over the Internet 150. The search interface web server 130 passes on this search request to the search engine web server 140 and receives search results in response thereto. The search results are initially ranked in accordance with the relevance algorithm used by the search engine web server 140. The search interface web server 130 then re-orders the search results in accordance with scores derived from notebook usage metrics. Upon receiving this information, the client computer 110 generates the GUI 310 with new display contents for HTML_bg, and the search results displayed in separate inline frames, which are represented in FIG. 3 as HTML1, HTML2, HTML3, and HTML4.

In the implementation where the functions of the search interface web server 130 and the search engine web server 140 are carried out by a single web server, the relevance algorithm of the search engine is modified to account for the usage metrics in the manner described herein. In such an implementation, the step of re-ordering the search results may be omitted.

In one embodiment where search results including individual search listings are ranked, the usage metrics examined by the search interface web server 130 for ranking the search results include: (1) the number of times a search result has been added to a notebook, (2) the number of times a search result has been viewed within a notebook, and (3) the number of click-throughs of a search result within a notebook. As an alterative to click-throughs, click-through rates (CTR) may be used, where CTR=(click-throughs of a search result)/(the number of times the search result has been viewed within a notebook). The following table provides some sample numbers of each of these usage metrics. There may be other usage metrics that are examined and they are labeled in the following table as “Other 1” and “Other 2.” For ranking the different search listings relative to one another, a weighting factor is applied to each usage metric and a score is compiled for each search listing.

| | | | | | Other |
|---|---|---|---|---|---|
| | Metric 1 | Metric 2 | Metric 3 | Other 1 | 2 |
| Search Listing 101 | 5 | 22 | 3 | | |
| Search Listing 102 | 7 | 65 | 6 | | |
| Search Listing 103 | 3 | 25 | 5 | | |

In another embodiment where search results including notebooks are ranked, the usage metrics examined by the search interface web server 130 for ranking the search results include: (1) the number of times the notebook has been e-mailed to another user or imported by another user, (2) the number of pages that have been added to a notebook that are relevant to the search query, (3) the number of times relevant pages within a notebook have been viewed, and (4) the number of click-throughs of the relevant pages within a notebook. As an alterative to click-throughs, click-through rates (CTR) may be used, where CTR=(click-throughs of a search listing within a notebook)/(the number of times the search listing has been viewed within the notebook). The “relevance” of a search listing with respect to search query may be determined using any of the conventional methods, e.g., by analyzing the location and frequency of keywords specified in the search query on a web page associated with the search listing. The following table provides some sample numbers of each of these usage metrics. There may be other usage metrics that are examined and they are labeled in the following table as “Other 1” and “Other 2.” For ranking the different notebooks relative to one another, a weighting factor is applied to each usage metric and a score is compiled for each notebook.

| | | | Metric | Metric | Other | Other |
|---|---|---|---|---|---|---|
| | Metric 1 | Metric 2 | 3 | 4 | 1 | 2 |
| Notebook 101 | 4 | 5 | 22 | 3 | | |
| Notebook 102 | 1 | 7 | 65 | 6 | | |
| Notebook 103 | 2 | 3 | 25 | 5 | | |

In an embodiment where search results including individual search listings and notebooks are ranked relative to one another, a first normalization factor is applied to the scores compiled for the individual search listings and a second normalization factor is applied to the scores compiled for the notebooks. The normalized scores are used to rank the individual search listings and notebooks relative to one another.

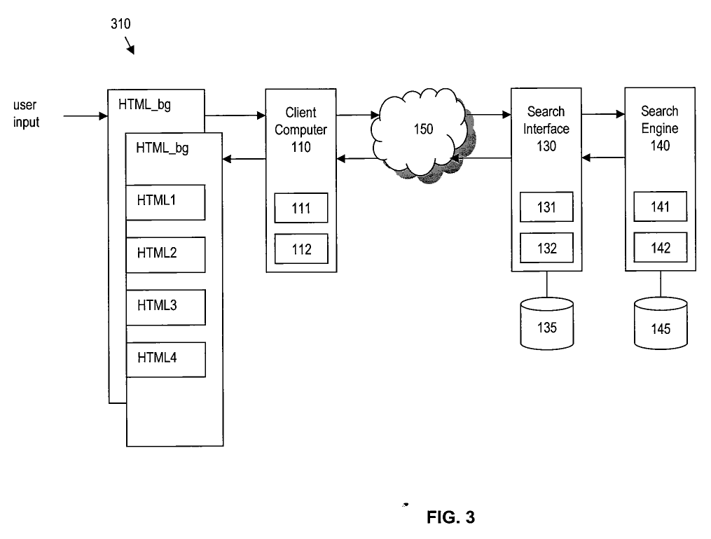

FIG. 4A is a flow diagram that illustrates the steps carried out by the search interface web server 130 to generate search results according to an embodiment of the present invention. In step 410, the search interface web server 130 receives a search query from a client computer 110 over the Internet 150. Then, in step 420, the search interface web server 130 performs the requested search through the search engine web server 140. The search engine web server 140 generates the search results in a particular order and transmits them to the search interface web server 130, which re-orders and stores them (step 430). The search interface web server 130 then generates a web page with the search results that have been re-ordered in step 430 (step 416), and transmits the web page to the client computer 110 over the Internet 150. The client computer 110 then generates a GUI that includes the search results received from the search interface web server 130, such as the one shown schematically in FIG. 2

FIG. 4B is a flow diagram that illustrates the steps carried out by the search interface web server 130 to re-order search results according to an embodiment of the present invention. In step 420, the scores of search results including individual search listings are determined as described above. In step 422, the scores of search results including notebooks are determined relative to the search query as described above. In step 424, the scores determined in step 420 and step 422 are normalized as described above. In step 426, the search results are re-ordered based on their normalized scores.

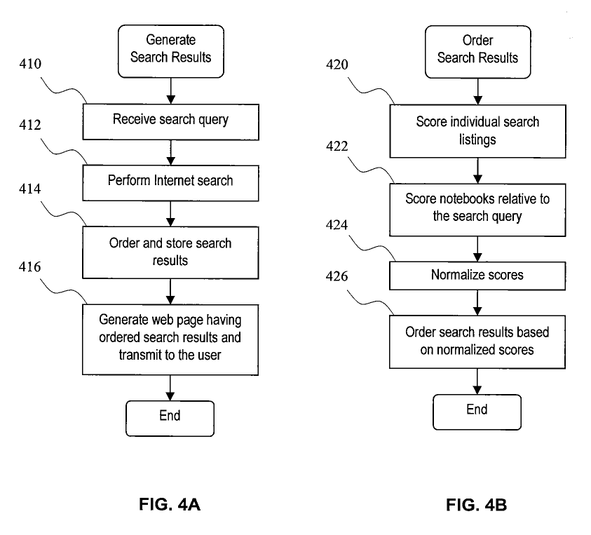

FIG. 5 is a schematic representation of a GUI according to another embodiment of the present invention that displays notebooks as part of search results. This GUI is generated by the client computer 110 based on content transmitted by the search interface web server 130. The GUI schematically represented in FIG. 5 has three different sections including a first section 510, a second section 520, and a third section 530. The first section 510 operates in the same manner as the first section 210 of FIG. 2, except that the first section 510 can be collapsed (or expanded after it has been collapsed) by clicking on the arrow 513. The drop region of the first section 510, identified with a darker background in FIG. 5, is active in either the expanded state or the collapsed state, so that search results can be added to a notebook by selecting them, dragging them to this region and then dropping them in this region. The second section 520 is a section for inputting a search query. The third section 530 is a section for displaying search results 531 that are responsive to the search query, and text advertisements (e.g., sponsored link 540) that are responsive to the search query. In the embodiment of the GUI shown in FIG. 5, a text advertisement appears directly underneath each notebook, such as under search result 531b.

Each of the three sections 510, 520, 530 comprises at least one inline frame. The first section 510 comprises one inline frame. The second section 520 comprises one inline frame. The third section 530 comprises multiple inline frames. Each search result 531 in the third section 530 is displayed in a separate inline frame, and each sponsored link 540 in the third section 530 is displayed in a separate inline frame. Some search results, such as search result 531b, may comprise notebooks. For these, the pages from the notebooks are displayed one at a time. Other pages of the notebooks can be accessed by clicking on GUI control for the previous page number (e.g., GUI control 532) or the next page number (e.g., GUI control 534). The page number of the current page is also displayed.

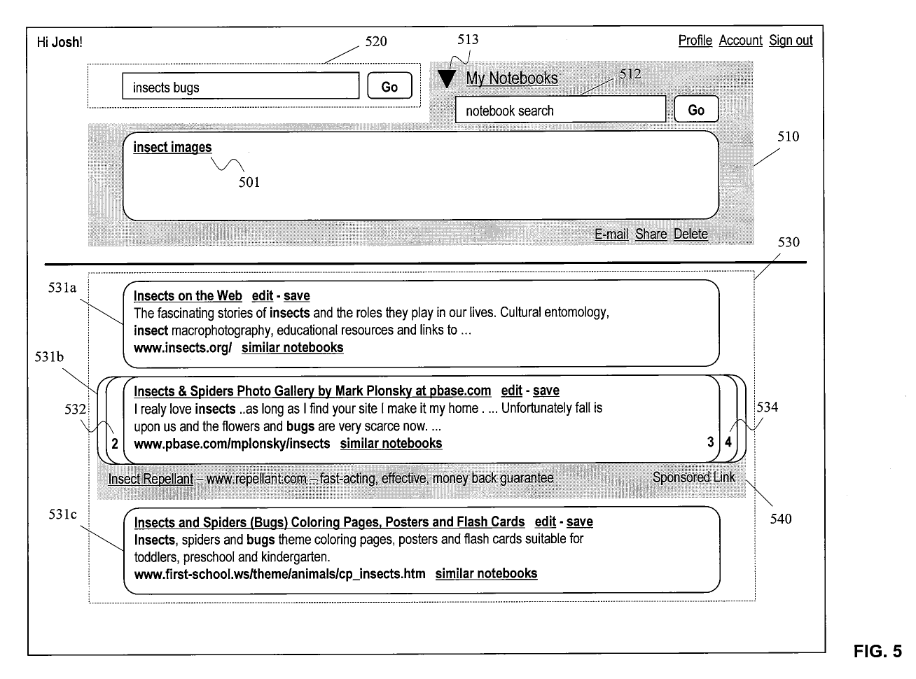

FIG. 6 is a flow diagram that illustrates the steps carried out by the search interface web server 130 to generate search results according to another embodiment of the present invention. In step 610, the search interface web server 130 receives a search query from a client computer 110 over the Internet 150. Then, in step 612, the search interface web server 130 performs the requested search through the search engine web server 140. The search engine web server 140 generates the search results in a particular order and transmits them to the search interface web server 130, which stores them (step 614). The search interface web server 130 then searches for all notebooks that include any of the search results and modifies the display contents in the following manner (step 616). If more than one notebook includes a search result, the score of each such notebook is computed relative to the search query as described above, and the most relevant notebook is selected for display in place of the search result. When this notebook is displayed, the notebook page corresponding to the search result will be displayed initially. In step 618, the web page having the display contents as modified in step 616 is transmitted to the client computer 110 over the Internet 150. The client computer 110 then generates a GUI that includes the display contents as modified in step 616, such as the one shown schematically in FIG. 5.

In another embodiment, a golden notebook may be generated in response to a search query and displayed to the user as the topmost search result. The golden notebook is a collection of relevant pages from notebooks that are determined to be the top N most relevant, where N can be any integer greater than 1, e.g., 5, 10, or 20.

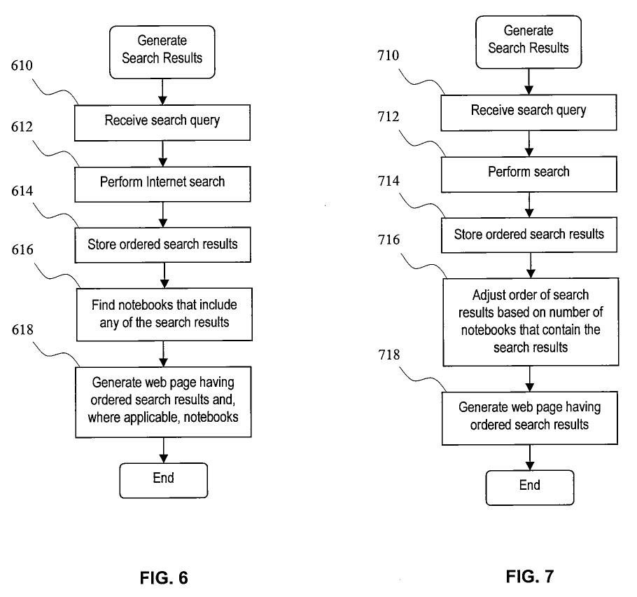

FIG. 7 is a flow diagram that illustrates the steps carried out by the search interface web server 130 to generate search results according to another embodiment of the present invention. In step 710, the search interface web server 130 receives a search query from a client computer 110 over the Internet 150. Then, in step 712, the search interface web server 130 performs the requested search through the search engine web server 140. The search engine web server 140 generates the search results in a particular order based on relevance and transmits them to the search interface web server 130, which stores them in that order (step 714). A relevance score is computed for each of the search results based on their ranking in the search results. In step 716, a second score is computed for each of the search results based on the number of times the search result has been added to notebooks and the order of the search results is adjusted based on their relevance scores and their second scores. Any type of adjustment may be used so long as, in general, a ranking for a search result improves the more times it is added to notebooks. For example, a search result with an initial ranking of 1 may lose its top ranking to a search result with an initial ranking of 2 if the former has been added to notebooks 0 times and the latter has been added to notebooks 100 times. In step 718, the web page having the display contents as modified in step 716 is transmitted to the client computer 110 over the Internet 150. The client computer 110 then generates a GUI that includes the display contents as modified in step 716.

The functionalities of the GUIs described above may be implemented in the web pages using a markup language, scripting languages and associated libraries that provide inline framing, drag and drop, and other dynamic visual effects and user interface elements provided by the Prototype JavaScript Framework via the Document Object Model. The library that is employed in the embodiments described above is known as “scriptaculous.”

While particular embodiments according to the invention have been illustrated and described above, those skilled in the art understand that the invention can take a variety of forms and embodiments within the scope of the appended claims.

What is claimed is:

1. A method for generating a page of search results in response to a search query, said method comprising the steps of:
receiving a search query;
storing search results that are responsive to the search query; and
transmitting a page of search results for display, wherein the page of search results include at least one search listing collection, and the at least one search listing collection includes at least two search listings that are to be displayed on said page of search results one at a time.

2. The method according to claim 1, wherein the search results include a first search listing collection and a second search listing collection, each search listing collection having at least two search listings, and wherein the display order of the first search listing collection and the second search listing collection on said page of search results is determined based on a usage metric of the first search listing collection and a usage metric of the second search listing collection.

3. The method according to claim 2, wherein each search listing collection includes a plurality of search listings, and the usage metric comprises the number of such search listings in said each search listing collection that are relevant to the search query.

4. The method according to claim 2, wherein the usage metric comprises the number of times the search listing collection has been e-mailed.

5. The method according to claim 1, wherein the search results include a first individual search listing and a second individual search listing, and the display order of the first individual search listing and the second individual search listing on said page of search results is determined based on the number of times the individual search listing has been added to a search listing collection.

6. The method according to claim 5, wherein the display order of the first individual search listing and the second individual search listing on said page of search results is further determined based on the number of times the individual search listing has been viewed within its respective search listing collection.

7. The method according to claim 1, further comprising the step of generating the search results that are responsive to the search query prior to the step of storing.

8. The method according to claim 7, further comprising the steps of issuing the search query to a third party and receiving the search results from the third party after the search results have been generated by the third party.

9. A method for generating a list of search results in response to a search query, said method comprising the steps of:
receiving a search query;
storing search results that are responsive to the search query;
identifying at least first and second search listing collections that include one of the search results;
selecting one of the first and second search listing collections for display in place of said one of the search results; and
transmitting the selected search listing collection for display.

10. The method according to claim 9, wherein the step of selecting is carried out based on a usage metric of the first and second search listing collections.

11. The method according to claim 10, wherein each search listing collection includes a plurality of search listings, and the usage metric comprises the number of such search listings in said each search listing collection that are relevant to the search query.

12. The method according to claim 11, wherein the usage metric comprises the number of times the relevant search listings within the search listing collection has been viewed.

13. The method according to claim 10, wherein the usage metric comprises the number of times the search listing collection has been e-mailed.

14. The method according to claim 9, further comprising the step of generating the search results that are responsive to the search query prior to the step of storing.

15. The method according to claim 14, further comprising the steps of issuing the search query to a third party and receiving the search results from the third party after the search results have been generated by the third party.

16. In a computer system that manages a plurality of search listing collections, a method for generating a page of search results in response to a search query, said method comprising the steps of:
receiving a search query;
storing search results that are responsive to the search query;
ordering the search results based on the number of times the search results have been added to search listing collections; and
transmitting a page of search results for display, wherein the page of search results include the ordered search results.

17. The method according to claim 16, wherein the stored search results have an order and, during the step of ordering, the order of the stored search results are adjusted based on the number of times the search results have been added to search listing collections.

18. The method according to claim 17, wherein the step of ordering includes the steps of:
computing a first score for each of the stored search results based on the relevance of the search result to the search query;
computing a second score for each of the stored search results based on the number of times the search result has been added to search listing collections; and
ordering the stored search results based on their first and second scores.

19. The method according to claim 18, wherein the first scores for the stored search results are correlated to their relevance ranks.

20. The method according to claim 19, wherein the relevance ranks are determined by a third party.
